(19) United States
(12) Patent Application Publication
(10) Pub. No.: US 2024/0410405 A1
(43) Pub. Date: Dec. 12, 2024

(54) FLUSH CLAMP TO SECURE AN OBJECT TO A WORKING SURFACE

(71) Applicant: CKnapp Sales, Inc., Goodfield, IL (US)

(72) Inventor: Brandon Meyer, Normal, IL (US)

(21) Appl. No.: 18/629,486

(22) Filed: Apr. 8, 2024

Related U.S. Application Data
(63) Continuation-in-part of application No. 29/894,230, filed on Jun. 7, 2023.
(63) Continuation-in-part of application No. 29/920,460, filed on Dec. 11, 2023.

(51) Int. Cl. F16B 2/12; A47B 97/00

(52) U.S. Cl. CPC F16B 2/12; A47B 97/00; A47B 2200/0085

(57) ABSTRACT

Flush clamps to secure units to working surfaces are disclosed herein. An example flush clamp includes a first member including a first portion in a first plane, the first portion having a first end and a second end, a second portion at the first end, the second portion in a second plane perpendicular to the first plane, and a third portion at the second end, the third portion in a third plane parallel to the second plane, the third portion having a hole, a second member including a fourth portion in a fourth plane parallel to the second plane, the second member at least partially between the second portion and the third portion, and a fastener to engage the second member, movement of the fastener to control a position of the second member relative to the second portion.

### RELATED APPLICATIONS

This patent arises from a continuation-in-part of U.S. patent application Ser. No. 29/894,230 (now U.S. Patent ______), which was filed on Jun. 7, 2023, and U.S. patent application Ser. No. 29/920,460 (now U.S. Patent ______), which was filed on Dec. 11, 2023. U.S. patent application Ser. No. 29/894,230 and U.S. patent application Ser. No. 29/920,460 are hereby incorporated herein by reference in their entirety. Priority to U.S. patent application Ser. No. 29/894,230 and U.S. patent application Ser. No. 29/920,460 is hereby claimed.

### FIELD OF THE DISCLOSURE

This disclosure relates generally to clamps and, more particularly, to a clamp to secure an object to a working surface.

### BACKGROUND

In recent years, customizable working areas have become increasingly popular due to a rise in the number of people working from home. Individual objects (e.g., drawers, cubbies, cabinets, etc.) that can be added to a working surface (e.g., table, desk) have become a popular way for a user to customize their working area to meet their specific wants and needs.

### BRIEF DESCRIPTION OF THE DRAWINGS

FIG. 1 illustrates example flush clamps connected to an example object in accordance with the teachings of this disclosure.

FIG. 2A is an isometric view of an example flush clamp of FIG. 1 in accordance with the teachings of this disclosure.

FIG. 2B is a front view of the example flush clamp of FIG. 1 in accordance with the teachings of this disclosure.

FIG. 2C is a side view of the example flush clamp of FIG. 1 in accordance with the teachings of this disclosure.

FIG. 3 is an exploded isometric view of the example flush clamp of FIG. 1 in accordance with the teachings of this disclosure.

FIG. 4A is a perspective view of example flush clamps, connected to an example object, in an open position in accordance with the teachings of this disclosure.

FIG. 4B is a perspective view of example flush clamps, connected to an example object, in a closed position in accordance with the teachings of this disclosure.

FIG. 5 is a flowchart representative of an example method of utilizing the example flush clamp of FIG. 1 in accordance with the teachings of this disclosure.

FIG. 6A illustrates other example flush clamps connected to another example object in accordance with the teachings of this disclosure.

FIG. 6B is a front view of the example flush clamps and example object of FIG. 6A in accordance with the teachings of this disclosure.

FIG. 6C is a side view of the example flush clamps and example object of FIG. 6A in accordance with the teachings of this disclosure.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

In recent years, individual objects (e.g., drawers, cubbies, cabinets, etc.) that can be added to a variety of working surfaces (e.g., tables, desks) have become a popular way for a user to customize their working area to meet their specific wants and needs. While such individual objects allow users to customize the storage/functionality characteristics of their working areas, individual objects must be capable of interfacing with working surfaces having different thicknesses. In order to meet these needs, some known objects incorporate clamps that can accommodate working surfaces having a thickness within a given range. However, such objects are fixed relative to the clamp. As a result, when used with a working surface that has a thickness less than the maximum thickness the clamp can accommodate, there is an undesirable gap between the top of the object and the bottom of the working surface. The gap is dependent on the thickness of the working surface and the maximum clamp capacity. Not only are such gaps considered aesthetically unappealing, but such gaps also restrict the size of objects that can fit under a working surface.

Certain examples provide flush clamps to secure an object to a working surface, the flush clamp including a frame (e.g., a first member) and a reference plate (e.g., reference surface, second member), a position of the reference plate relative to the frame adjustable such that the reference plate sits flush against a bottom of the working surface and the frame sits flush against a top of the working surface when the flush clamp is tightened. The flush clamp can then be connected to a variety of objects, as well as a variety of working surfaces with variable thickness such that the object sits flush against the bottom of the working surface. In some examples, the flush clamp reduces (e.g., eliminates) a gap between the object and the working surface. In some examples, the flush clamp allows for an increased sized object to be used with a working surface of a given height due to elimination of the gap between the object and the working surface. In some examples, the flush clamp increases the stability of the object's connection to the working surface.

In some examples, a flush clamp includes a first member (e.g., frame), a second member (e.g., reference plate), and a first fastener to engage the second member, movement of the first fastener to control a position of the second member relative to the first member. In some examples, the second member is movable between an open position and a closed position, the flush clamp to clamp a working surface when the second member is in the closed position. In some examples, the first fastener secures the flush clamp to a working surface when tightened by clamping the working surface between the first member and the second member. In some examples, the second member is configured to connect to a surface of an object, such that the top of the object is aligned with the top of the second member. In some examples, the flush clamp includes a second fastener to secure the second member to the first member. In some examples, the second member is movably connected to the first member such that the second member can slide relative to the first member when the second fastener is in a first position and the second member is restricted from moving relative to the first member when the second fastener is in a second position.

In some examples, the first member includes a middle portion (e.g., a first portion), a first end portion (e.g., a second portion), and a second end portion (e.g., a third portion). In some examples, the middle portion extends along a first plane, the second end portion extends along a second plane perpendicular to the first plane, and the first end portion extends along a third plane parallel to the second plane. In some examples, the first plane is a vertical plane and the second and third planes are horizontal planes. In some examples, the first end portion and the second end portion connect to the middle portion at approximately 90-degree angles. In some examples, the first end portion, the second end portion, and the middle portion form a curved shape (e.g., substantially C-shaped). In some examples, the second end portion includes a first hole (e.g., bore), the first hole to receive the first fastener. In some examples, the middle portion includes a slot to receive the second fastener.

In some examples, the second member is at least partially between the first end portion and the second end portion. In some examples, the second member includes a first segment (e.g., a fourth portion) in a fourth plane parallel to the second plane and a second segment (e.g., a fifth portion) in a fifth plane perpendicular to the first plane and the second plane. In some examples, the first segment and the second segment form an approximately 90-degree angle (e.g., the second member is substantially L-shaped). In some examples, the second member includes a second hole to receive the second fastener via the slot. In some examples, the second member includes a lip, the lip including the second hole, the lip to engage the middle portion of the first member.

In some examples, the first fastener is a screw. In some examples, the first fastener is a bolt. In some examples, the first fastener has a first end and a second end, the second end to engage the second member. In some examples, the first end of the first fastener includes an ergonomic knob to enable more comfortable tightening of the fastener. In some examples, the second end of the first fastener includes a surface to engage the second member. In some examples, the surface is adjustable relative to the first fastener, such that the surface adjusts to the second member as the first fastener is tightened, providing an improved contact surface area.

The flush clamp and associated working surface(s) can be implemented in a variety of configurations. For example, the flush clamp can clamp two parallel working surfaces. In another configuration, the flush clamp can support two perpendicular working surfaces (e.g., a corner flush clamp can support one or more working surfaces arranged in an L shape).

Examples disclosed herein enable manufacture of a flush clamp configured to allow adjustment of a reference plate relative to a frame. Example flush clamps disclosed herein include a frame including a first portion having a first end and a second end, a second portion at the first end, the second portion perpendicular to the first portion, and a third portion at the second end, the second portion parallel to the second portion, the third portion having a hole, and a reference plate movably connected to the frame, the reference plate including a first segment at least partially between and parallel to the second portion and the third portion.

Example flush clamps disclosed herein include fasteners to secure the flush clamp to a working surface(s) and secure the reference plate to the frame. Example fasteners disclosed herein include enable adjustment of the position of the reference plate relative to the frame to cause the flush clamp to clamp the working surface.

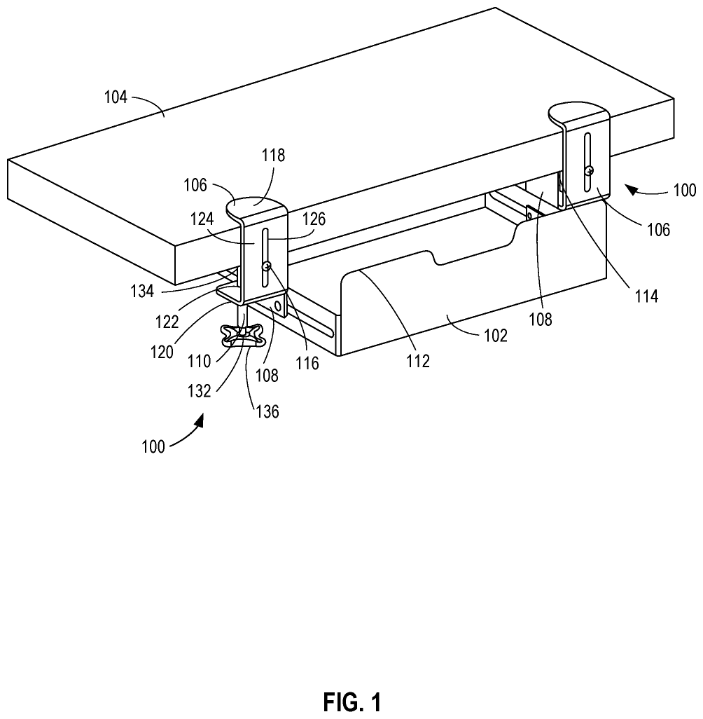

FIG. 1 illustrates example flush clamps 100 connected to an example object 102. Example flush clamps 100 secure an object 102 to a working surface 104, the flush clamps 100 including a frame (e.g., first member) 106 and a reference plate 108 (e.g., a reference surface, a second member), a position of the reference plate 108 relative to the frame 106 adjustable such that the reference plate 108 sits flush against a bottom of the working surface 104 and the frame 106 sits flush against a top of the working surface 104 when the flush clamp 100 is tightened. In the illustrated example of FIG. 1, the object 102 is connected to the working surface 104 by two flush clamps 100. In some examples, fewer (e.g., one) or more (e.g., 3, 4, etc.) flush clamps are used to connect an object 102 to a working surface 104. The flush clamp can be connected to a variety of objects 102, as well as a variety of working surfaces 104 with variable thickness such that the object 102 sits flush against the bottom of the working surface 104.

In some examples, a flush clamp 100 includes the first member 106, the second member 108 (e.g., reference plate), and a first fastener 110 (e.g., a rod, a threaded rod, a screw, etc.) to engage the second member 108, movement of the first fastener 110 control a position of the second member 108 relative to the first member 106. In some examples, the second member 108 is movable between an open position and a closed position, the flush clamp 100 to clamp a working surface 104 when the second member 108 is in the closed position. In some examples, the first fastener 110 secures the flush clamp 100 to a working surface 104 when tightened by clamping the working surface 104 between the first member 106 and the second member 108. In some examples, the second member 108 is configured to connect to a surface of an object 102, such that the top 112 of the object 102 is aligned with the top 114 of the second member 108. In some examples, the flush clamp 100 includes a second fastener 116 to secure the second member 108 to the first member 106. In some examples, the second member 108 is movably connected to the first member 106 such that the second member 108 can slide relative to the first member 106 when the second fastener 116 is in a first position and the second member 108 is restricted from moving relative to the first member 106 when the second fastener 116 is tightened to a second position.

In some examples, the first member 106 includes a middle portion 124, a first end portion 118, and a second end portion 120. In some examples, the middle portion 124 is in a first plane, the first end portion 118 is in a second plane perpendicular to the first plane, and the second end portion 120 is in a third plane parallel to the second plane. In some examples, the first plane is a vertical plane and the second and third planes are horizontal planes.

In some examples, the first end portion 118 and the second end portion 120 connect to the middle portion 124 at approximately 90-degree angles. In some examples, the first end portion 118, the second end portion 120, and the middle portion 124 form a curved shape (e.g., substantially c-shaped). In some examples, the second end portion 120 includes a first hole 122, the first hole 122 to receive the first fastener 110. In some examples, the middle portion 124 includes a slot 126 to receive the second fastener 116.

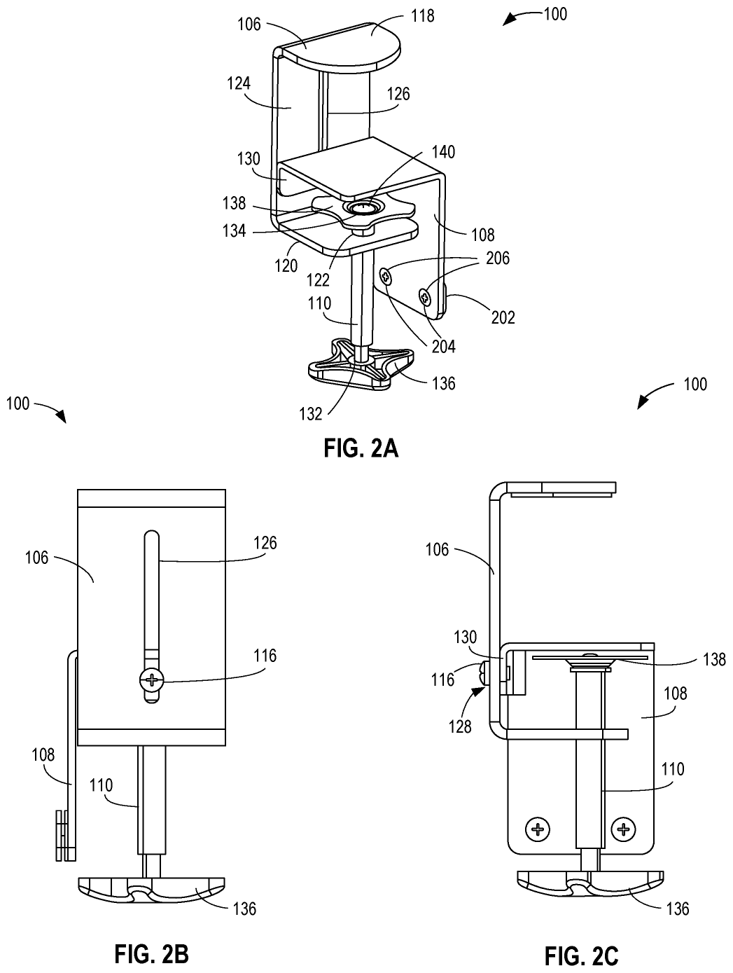

In some examples, the second member 108 is at least partially between the first end portion 118 and the second end portion 120. In some examples, the second member 108 includes a first segment (e.g., a fourth portion) 142 (not visible in FIG. 1, see the example of FIG. 2A) in a fourth plane parallel to the second plane and a second segment (e.g., a fifth portion) 144 (not visible in FIG. 1, see the example of FIG. 2A) in a fifth plane perpendicular to the first plane and the second plane. In some examples, the first segment 142 and the second segment 144 form an approximately 90-degree angle (e.g., the second member is substantially L-shaped). In some examples, the second member 108 may be a flat plate. In some examples, two or more flush clamps 100 may share a common second member 108. For example, the common second member 108 may be a flat plate spanning across an object 102. In some examples, the second member 108 includes a second hole 128 (not visible in FIG. 1, see the example of FIG. 2C) to receive the second fastener 116 via the slot 126. In some examples, the second member 108 includes a lip 130 (not visible in FIG. 1, see the example of FIG. 2C), the lip 130 including the second hole 128, the lip 130 to engage the middle portion 124 of the first member 106.

In some examples, the first fastener 110 is a screw, a bolt, or a threaded rod. In some examples, the first fastener 110 has a first end 132 and a second end 134, the second end 134 to engage the second member 108. In some examples, the first end 132 of the first fastener includes an ergonomic knob 136 to enable more comfortable tightening of the fastener 110. In some examples, the second end 134 of the first fastener 110 includes a surface 138 (now shown in FIG. 1) to engage the second member 108. In some examples, the surface 138 is connected to the first fastener via a third fastener 140. In some examples, the surface 138 is adjustable relative to the first fastener 110, such that the surface 138 conforms to the second member 108 as the first fastener 110 is tightened, providing an improved contact surface area.

In the illustrated example of FIG. 1, the object 102 is an open slotted drawer with sliding racks. Example flush clamps 100 connect to the object 102 via the sliding racks so that the drawer may slide relative to the flush clamps 100 and therefore the working surface 104. In other examples, the object 102 can be a closed drawer, including a casing around the drawer, the flush clamps 100 to connect to the casing. In some examples, the object 102 is a keyboard tray, a cubby, a cabinet, or any other compartment or component desired to be connected to a working surface. In some examples, the configuration of the flush clamp 100, and any individual components of the flush clamp, varies based on the kind of object 102 being attached to the working surface. For example, as discussed above, the second member 108 can be a flat plate spanning across the object 102 when the object has a casing to provide for improved stability of the object.

FIG. 2A is an isometric view of the example flush clamp 100 of FIG. 1. In some examples, the flush clamp 100 includes the first member 106, the second member 108 (e.g., reference plate), and a first fastener 110 (e.g., a rod, a threaded rod, a screw, etc.) to engage the second member 108, movement of the first fastener 110 between a first position and a second position to control the position of the second member 108 relative to the first member 106. In some examples, the second end 134 of the first fastener 110 includes a surface 138 to engage the second member 108. In some examples, the surface 138 is connected to the first fastener via a third fastener 140. In some examples, the surface 138 is pivotable relative to the first fastener 110, such that the surface 138 conforms to the second member 108 as the first fastener 110 is tightened, providing an improved contact surface area. In some examples, the flush clamp 100 includes a rack plate 202 to connect to the object 102. The flush clamp 100 includes fourth fasteners 204 passing through the second member 108 at third holes 206 to connect to the object 102.

FIG. 2B is a front view of the example flush clamp 100 of FIG. 1. FIG. 2C is a side view of the example flush clamp of FIG. 1. In some examples, the flush clamp 100 includes a second fastener 116 to secure the second member 108 to the first member 106. In some examples, the second member 108 is movably connected to the first member 106 such that the second member 108 can slide relative to the first member 106 when the second fastener 116 is in a first position and the second member 108 is restricted from moving relative to the first member 106 when the second fastener 116 is tightened to a second position. In some examples, the second member 108 includes a second hole 128 to receive the second fastener 116 via the slot 126. In some examples, the second member 108 includes a lip 130, the lip 130 including the second hole 128, the lip 130 to engage the middle portion 124 of the first member 106. When the second fastener 116 is in the first position, there is gap between the lip 130 and the first member 106. When the second fastener 116 is tightened to the second position, the lip 130 engages the middle portion 124 of the first member 106, such that the position of the second member 108 relative to the first member 106 is fixed.

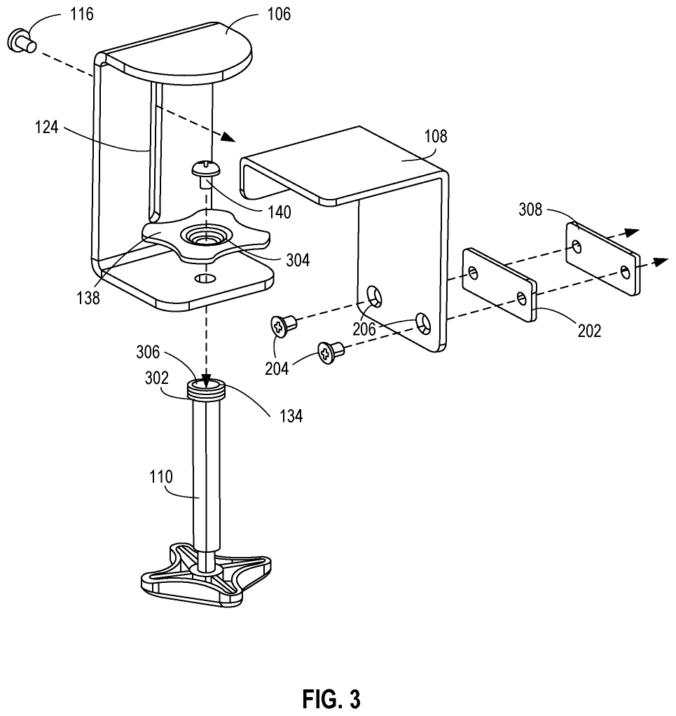

FIG. 3 is an exploded isometric view of the example flush clamp 100 of FIG. 1. In some examples, the second end 134 of the first fastener 110 includes a surface 138 to engage the second member 108. In some examples, the surface 138 is connected to the first fastener via a third fastener 140. In some examples, the second end 134 of the first fastener 110 includes threads 302 and the surface 138 includes a threaded hole 304. The threads 302 engage the threaded hole 304 and the third fastener 140 connected to the first fastener 110 via a fourth hole 306. In some examples, the surface 138 is a pivotable surface, pivotable about the end of the first fastener 110.

In some examples, the flush clamp 100 includes a rack plate 202 to connect to the object 102. The flush clamp 100 includes fourth fasteners 204 passing through the second member 108 at third holes 206 to connect to the object 102. In some examples, the flush clamp 100 includes second rack plate 308. The first rack plate 202 and the second rack plate 308 engage the object 102 on a first side and a second side of a surface of the object 102, respectively.

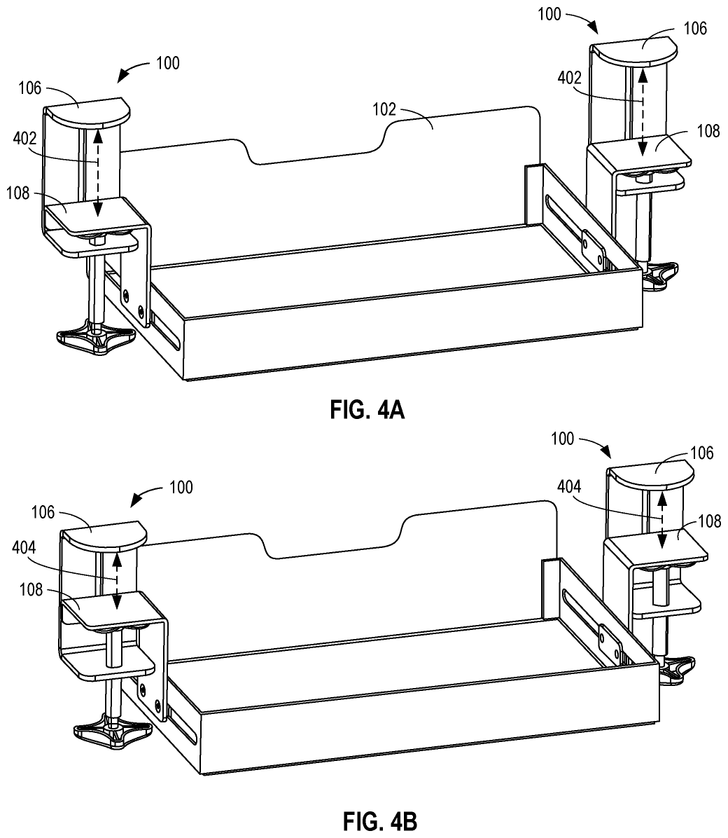

FIG. 4A is a perspective view of example flush clamps 100, connected to an example object 102, in an open position. FIG. 4B is a perspective view of example flush clamps 100, connected to the example object 102, in a closed position. In the open position, neither the first fasteners 110 nor the second fasteners 116 are tightened. The object 102 is connected to the flush clamps 100. The distance between the second portions 118 and the fourth portions 142 of the second members 108 is a first distance 402. A user can connect the flush clamps 100, and, therefore, the object 102, to a working surface 104 (not shown in FIGS. 4A-4B) with a thickness equal to or less than the distance 402. Because the second fasteners 116 have not been tightened, the second members 108, and, therefore, the object 102, can slide up and down relative to the first members 106. In the closed position, both the first fasteners 110 and the second fasteners 116 are tightened. The distance between the second portions 118 and the fourth portions 142 of the second members 108 is a second distance 404, the second distance 404 smaller than the first distance 402, to clamp (e.g., clench, grip, squeeze, etc.) a working surface having a thickness equal to the second distance 404. In the illustrated example of FIG. 4B, the closed position corresponds to the second distance 404. In other examples, the closed position can correspond to a distance larger or smaller than the second distance 404, depending on the thickness of the working surface to be clamped. Because the second fasteners 116 are tightened in the closed position, the second members 108, and therefore the object 102, cannot slide up and down relative to the first members 106 (and, therefore, the working surface 104). Thus, the object 102 is secured to the working surface 104.

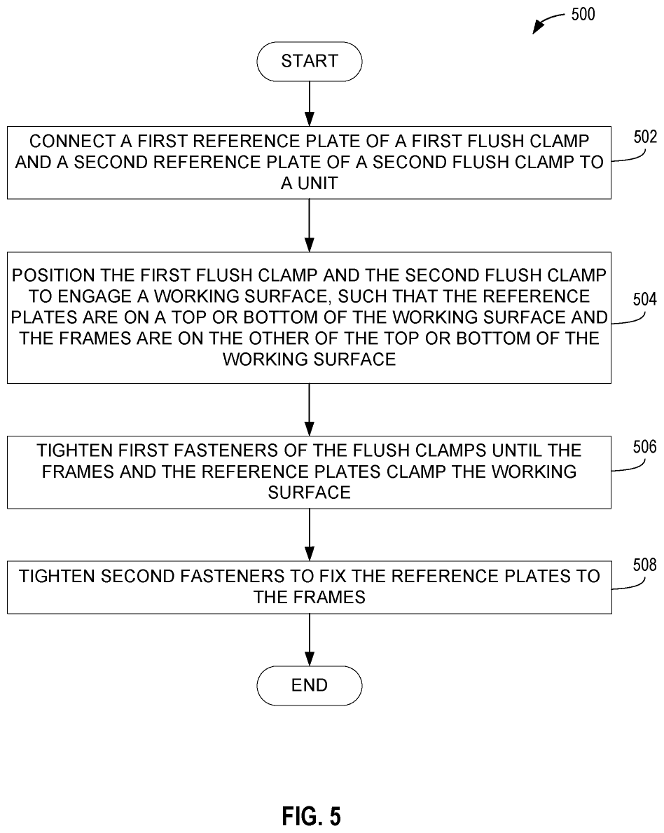

FIG. 5 is a flowchart representative of an example method 500 of utilizing the example flush clamp 100 of FIG. 1. At block 502, A user connects a first reference plate 108 of a first flush clamp 100 and a second reference plate 108 of a second flush clamp 100 to an object 102. At block 504, a user positions the first flush clamp 100 and the second flush clamp 100 to engage a working surface 104, such that the reference plates 108 are on a top or bottom of the working surface 104 and the frames 106 are on the other of the top or bottom of the working surface 104. At block 506, the user tightens the first fasteners 110 of the flush clamps 100 until the frames 106 and the reference plates 108 clamp the working surface 104. At block 508, the user tightens the second fasteners 116 to fix the reference plates 108 to the frames 106. Then the example method 500 terminates.

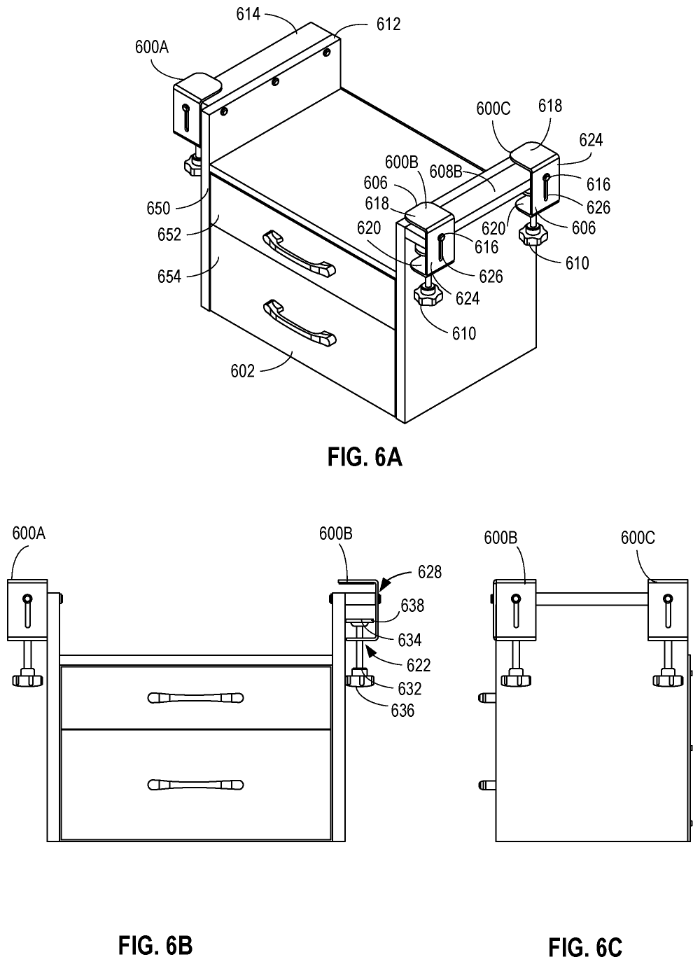

FIG. 6A illustrates example flush clamps 600A-C connected to an example object 602. FIG. 6B is a front view of the example flush clamps and the example object of FIG. 6A. FIG. 6C is a side view of the example flush clamps and the example object of FIG. 6A. Example flush clamps 600A-C secure the object 602 to a working surface. The flush clamps 600A-C include a frame 606 and a reference plate 608. In the illustrated example of FIG. 6A, the flush clamps 600B-C share a common reference plate 608B, a position of the reference plate 608B is adjustable relative to the frames 606B-C such that the reference plate 608B sits flush against the bottom of the working surface when the flush clamps 600B-C are tightened. The example object 602 is a drawer system including a frame 650, a first drawer 652, and a second drawer 654. The flush clamps 600 can be connected to a variety of objects 602, as well as a variety of working surfaces.

In some examples, the flush clamps 600 include the frame 606, the reference plate 608, and a first fastener 610 to engage the reference plate 608. Movement of the first fastener 610 controls a position of the reference plate 608 relative to the frame 606. In some examples, the reference plate 608 is movable between an open position and a closed position, and the flush clamps 600 clamp a working surface when the reference plate 608 is in the closed position. In some examples, the first fastener 610 secures the flush clamp 600 to a working surface when tightened by clamping the working surface between the frame 606 and the reference plate 608. In some examples, the reference plate 608 is configured to connect to a surface of an object 602, such that the top 612 of the object 602 is aligned with the top 614 of the reference plate 608. In some examples, the flush clamp 600 includes a second fastener 616 to secure the reference plate 608 to the frame 606. In some examples, the reference plate 608 is movably connected to the frame 606 such that the reference plate 608 can slide relative to the frame 606 when the second fastener 616 is in a first position and the reference plate 608 is restricted from moving relative to the frame 606 when the second fastener 616 is tightened to a second position.

In some examples, the frame 606 includes a middle portion 624, a first end portion 618, and a second end portion 620. In some examples, the middle portion 624 is in a first plane, the first end portion 618 is in a second plane perpendicular to the first plane, and the second end portion 620 is in a third plane parallel to the second plane. In some examples, the first plane is a vertical plane and the second and third planes are horizontal planes. In some examples, the first end portion 618 and the second end portion 620 connect to the middle portion 624 at approximately 90-degree angles. In some examples, the first end portion 618, the second end portion 620, and the middle portion 624 form a curved shape (e.g., substantially c-shaped). In some examples, the second end portion 620 includes a first hole 622, the first hole 622 to receive the first fastener 610. In some examples, the middle portion 624 includes a slot 626 to receive the second fastener 616.

In some examples, the reference plate 608 is at least partially between the first end portion 618 and the second end portion 620. In the illustrated example of FIG. 6A, the reference plate 608 is a flat plate. In some examples, the reference plate 608 includes a first segment in a fourth plane parallel to the second plane and a second segment in a fifth plane perpendicular to the first plane and the second plane. In some examples, the first segment and the second segment form an approximately 90-degree angle (e.g., the reference plate is substantially L-shaped). In some examples, the reference plate 608 includes a second hole 628 to receive the second fastener 616 via the slot 626. In some examples, the reference plate 608 includes a lip, the lip including the second hole 628, the lip to engage the middle portion 624 of the frames 606.

In some examples, the first fastener 610 is a screw, a bolt, or a threaded rod. In some examples, the first fastener 610 has a first end 632 and a second end 634, the second end 634 to engage the reference plate 608. In some examples, the first end 632 of the first fastener includes an ergonomic knob 636 to enable more comfortable tightening of the fastener 610. In some examples, the second end 634 of the first fastener 610 includes a surface 638 to engage the reference plate 608. In some examples, the surface 638 is connected to the first fastener via a third fastener 640 (not shown in FIGS. 6A-6C). In some examples, the surface 638 is pivotable relative to the first fastener 610, such that the surface 638 conforms to the reference plate 608 as the first fastener 610 is tightened, providing an improved contact surface area.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

From the foregoing, it will be appreciated that example systems, apparatus, articles of manufacture, and methods have been disclosed allow users to connect a flush clamp to a variety of objects and a variety of working surfaces such that the objects sit flush against the working surfaces. Users can avoid gaps that often result from existing clamps, which are unpleasant to look at and reduce the amount of space that objects can occupy underneath working surfaces. The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A flush clamp comprising:
a first member including:
a first portion in a first plane, the first portion having a first end and a second end;
a second portion at the first end, the second portion in a second plane perpendicular to the first plane; and
a third portion at the second end, the third portion in a third plane parallel to the second plane, the third portion having a hole;
a second member including a fourth portion in a fourth plane parallel to the second plane, the second member at least partially between the second portion and the third portion; and
a fastener to engage the second member, movement of the fastener to control a position of the second member relative to the second portion.

2. The flush clamp of claim 1, further including a second fastener, wherein the first portion has a slot and the second member has a second hole to receive the second fastener via the slot, movement of the second member along the slot enabled when the second fastener is in a first position and movement of the second member along the slot restricted when the second fastener is tightened to a second position.

3. The flush clamp of claim 2, wherein the second member includes a lip, the lip including the second hole.

4. The flush clamp of claim 1, wherein a distance between the second member and the second portion is a first distance when the second member is in an open position and the distance between the second member and the second portion is a second distance when the second member is in a closed position, the second distance smaller than the first distance.

5. The flush clamp of claim 4, wherein the second member and the second portion clamp a working surface when the second member is in the closed position.

6. The flush clamp of claim 1, wherein the second member includes a fifth portion in a fifth plane perpendicular to the first plane and the second plane.

7. The flush clamp of claim 1, wherein the fastener includes a pivotable surface to engage the second member.

8. The flush clamp of claim 1, wherein the second member is connected to an object.

9. The flush clamp of claim 8, wherein the object is one of a cubby, keyboard tray, drawer, or cabinet.

10. The flush clamp of claim 1, wherein the fastener includes an ergonomic knob.

11. A clamp comprising:
a frame including:
a first portion having a first end and a second end;
a second portion at the first end, the second portion perpendicular to the first portion; and
a third portion at the second end, the second portion parallel to the second portion, the third portion having a hole;
a reference plate movably connected to the frame, the reference plate including a first segment at least partially between and parallel to the second portion and the third portion; and
a rod disposed in the hole, the rod engaging the portion of the reference plate, movement of the rod to control a position of the reference plate relative to the frame.

12. The clamp of claim 11, further including a screw, wherein the first portion has a slot and the reference plate has a second hole to receive the screw via the slot, movement of the reference plate relative the frame allowed when the screw is in a first position and movement of the reference plate relative the frame restricted when the screw is tightened to a second position.

13. The clamp of claim 12, wherein the reference plate has a lip, the lip including the second hole.

14. The clamp of claim 11, wherein a distance between the reference plate and the first end is a first distance when the reference plate is in an open position and the distance between the reference plate and the first end is a second distance when the reference plate is in a closed position, the second distance smaller than the first distance.

15. The clamp of claim 14, wherein the reference plate and the second portion clamp a working surface when the reference plate is in the closed position.

16. The clamp of claim 11, wherein the reference plate includes a second segment perpendicular to the first portion and the first segment.

17. The clamp of claim 11, wherein the rod includes a pivotable surface to engage the reference plate.

18. The clamp of claim 11, wherein the reference plate is connected to an object.

19. The clamp of claim 18, wherein the object is one of a cubby, keyboard tray, drawer, or cabinet.

20. The clamp of claim 11, wherein the rod includes an ergonomic knob.
